(19) United States
(12) Patent Application Publication
(10) Pub. No.: US 2007/0001334 A1
(43) Pub. Date: Jan. 4, 2007

(54) Ceiling tiles and a process for the manufacture thereof

(75) Inventor: Vangala Pattabhi, New Delhi (IN)

Correspondence Address: THE WEBB LAW FIRM, P.C., 700 KOPPERS BUILDING, 436 SEVENTH AVENUE, PITTSBURGH, PA, 15219, US

(73) Assignee: ANDHRA POLYMERS PRIVATE LIMITED, BEGUMPET (IN)

(21) Appl. No.: 10/545,526

(22) PCT Filed: Dec. 22, 2003
(86) PCT No.: PCT/IN03/00396

§ 371 Date: Aug. 30, 2006

(51) Int. Cl. B28B 1/26

(52) U.S. Cl. 264/87

(57) ABSTRACT

A process for preparation of improved ceiling tiles having different densities at desired points involves the step of preparing a slurry mix of 40-45% hydrated calcium silicate gel and a low density binder; 20-25% reinforcing fibre selected from mineral wool, glass wool and paper pulp; 3-5% gypsum, cellulose pulp and fillers selected from pulverized fly ash and calcium carbonate, pouring the slurry mix into a mould, introducing a false form, subjecting to vacuum and pressure to obtain the more or less material at desired points, removing the false form and further subjecting the semisolid slurry to pressure from top to produce tile with or without reinforcing ribs.

### FIELD OF INVENTION

The invention relates to improved ceiling titles and a process for the manufacture thereof. Though reference is made herein to ceiling tiles, such a reference is not intended to imply any limitation on the scope of the invention as the tiles, if required and found applicable, may also be used for any other application.

### PRIOR ART

Ceiling tiles presently known in the art, are mostly made of mineral fibres with fillers and binded with organic binders. Ceiling tiles having gypsum reinforced with cellulose fibres, are also in extensive use. These tiles have satisfactory sound and thermal properties. However these tiles have certain disadvantage.

A disadvantage of the above ceiling tiles is that they have limited resistance to water and fire.

Another disadvantage of the above ceiling tiles is that these tiles have poor edge strength, due to which, when these are soaked in water, they tend to crumble and break at edges during handling.

Flat products are used in the application for suspended ceiling in standard grids manufactured for this purpose. The materials used in the known art are gypsum, boards, mineral fibre boards and high density and low thickness boards such as calcium silicate boards.

A disadvantage of the above products is that the high-density materials such as calcium silicate are heavy and being low in thickness, these cannot be modified for better acoustics.

Another disadvantage of gypsum board and mineral wool tiles is that they have low moisture resistance and cannot stand in high humidity environment.

### OBJECTS OF PRESENT INVENTION

An object of the present invention is to provide improved ceiling tiles and a process for the manufacture thereof.

Another object of the present invention is to provide improved ceiling tiles, which are light weight.

Still another object of the present invention is to provide improved ceiling tiles, which are strong enough for easy handling.

Further object of the present invention is to provide improved ceiling tiles having reinforced edges and reinforcing ribs at desired points in the tile.

Still further object of the present invention is to provide improved ceiling tiles having higher moisture resistance.

Yet further object of the present invention is to provide improved ceiling tiles having good thermal conductivity.

Even further object of the present invention is to provide improved tiles having higher sound absorption.

### STATEMENT OF INVENTION

According to this invention there is provided a process for preparation of improved ceiling tiles having different densities at desired points comprising in the step of preparing a slurry mix of 40-45% hydrated calcium silicate gel and a low density binder; 20-26% reinforcing fibre selected from mineral wool, glass wool and paper pulp; 3-5% gypsum, cellulose pulp and fillers selected from pulverized fly ash and calcium carbonate, pouring the slurry mix into a mould, introducing a false form, subjecting to vacuum and pressure to obtain the more or less material at desired points, removing the false form and further subjecting the semisolid slurry to pressure from top to produce tile with or without reinforcing ribs.

Further, according to this invention there is provided improved ceiling tiles having different densities at desired locations comprising 40-45% hydrated calcium silicate gel and a low density binder; 20-25% reinforcing fibre selected from mineral wool, glass wool and paper pulp; 3-5% gypsum, cellulose pulp and fillers selected from pulverized fly ash and calcium carbonate.

The quantity of hydrated calcium silicate has been optimized in the present invention to be in the range of 45 to 50% as it has been determined after extensive research that any further increase in its quantity of calcium silicate beyond 50%, gives only very marginal increase in strength as shown in FIG. 4.

### DESCRIPTION OF FIGURES

The present invention is illustrated with accompanying figures, which are given to illustrate an embodiment of the present invention. These are not intended to be taken restrictively to imply any limitation on the scope of the present invention. In the accompanying figures.

FIG. 1: shows the flow chart of the process for manufacture of ceiling tiles of the present invention.

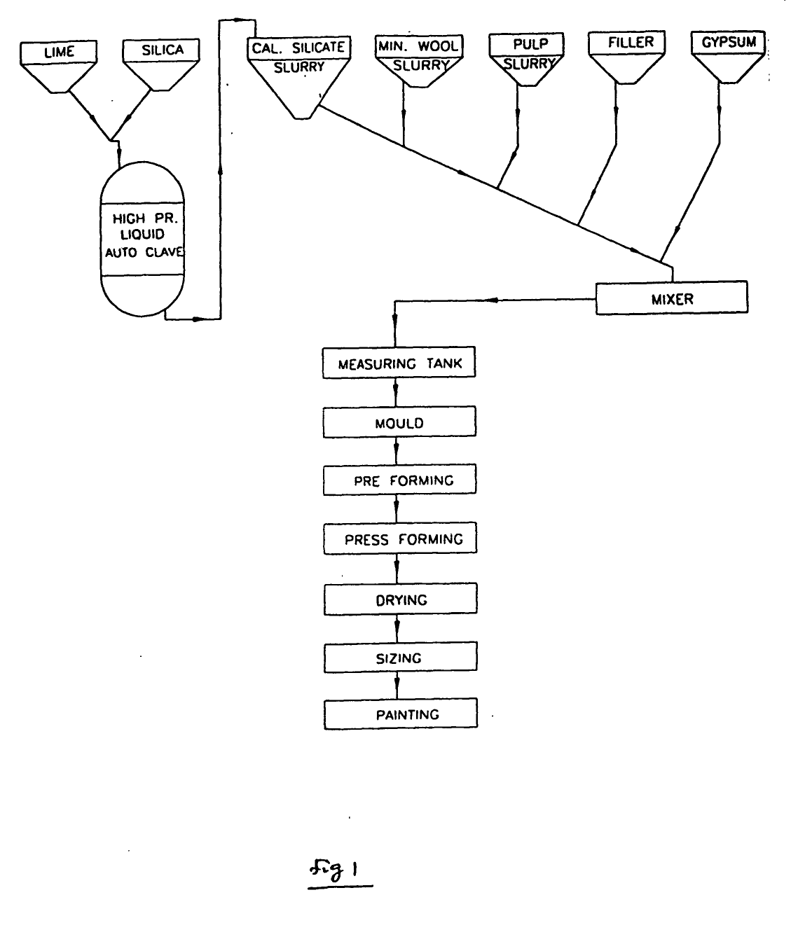

FIG. 2(a) to 2(e); illustrates the different steps of process after mixing of slurry.

FIG. 3: shows the rear side of the panel with reinforcing edges.

FIG. 4: shows the relationship between increase in strength of tile and the quantity of hydrated calcium silicate.

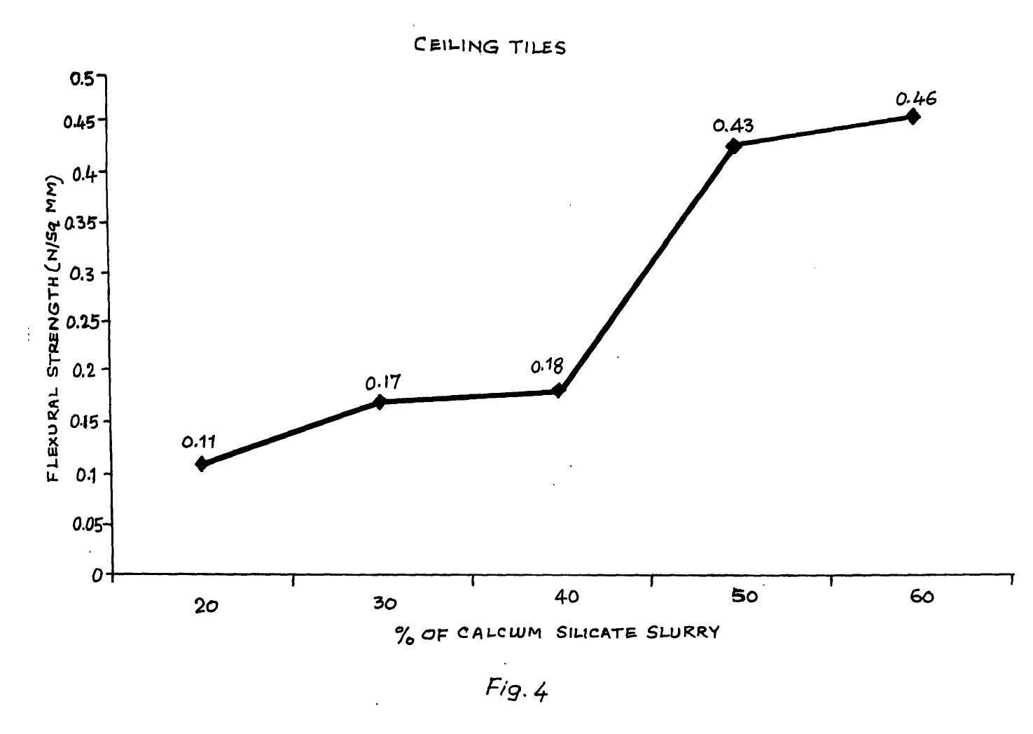

### DESCRIPTION OF INVENTION

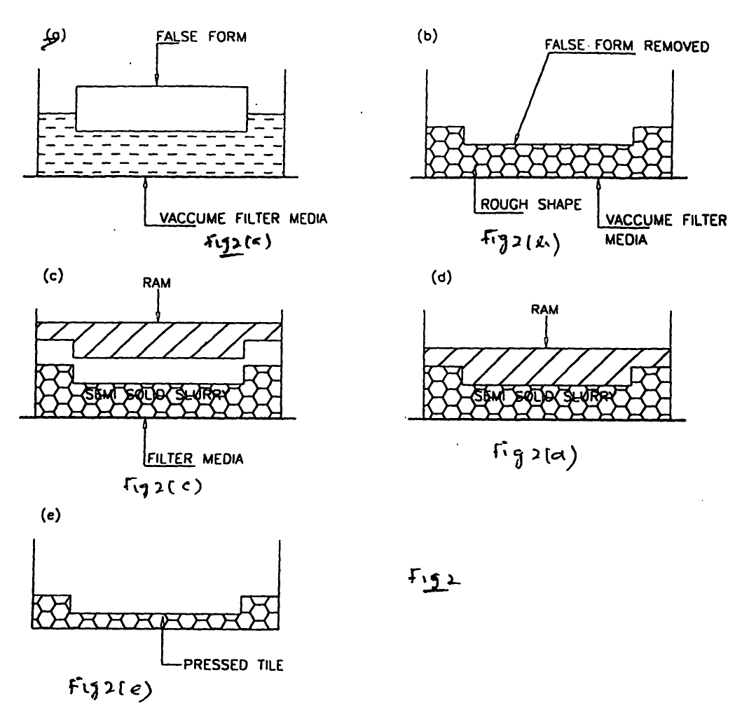

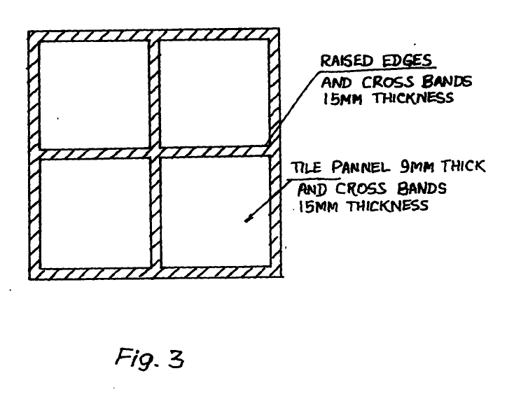

According to this invention, hydrated calcium silicate gel is first prepared by making a water-based slurry of lime and silica by method known in the art. The slurry thus prepared is cooked in a pressure vessel by injecting high-pressure steam into the vessel. The hydrated calcium silicate slurry thus prepared, is mixed with mineral wool, glass wool, cellulose pulp and fillers such a fly ash, calcium carbonate. In preparing the above mixture, slurry of hydrated calcium silicate is taken preferably in quantity 45 to 50% by weight of mixture, mineral wool is preferably taken in quantity 20-25% by weight cellulose pulp is preferably taken in quantity around 2%, gypsum is taken in preferred quantity of 3 to 5% by weight, while the rest is fillers such as fly ash, calcium carbonate. One of the important features of present invention relates to distributing varying amounts of materials, selectively in tiles. This is achieved by introducing false form into the container of slurry so that slurry stands at different levels as shown in FIG. 2(a). It is subjected to vacuum and pressure to produce tiles with or without reinforcing ribs, having more or less material at desired points, which is further subjected to pressure from top ram (platen) having shape to get different densities as required (FIG. 2d). By synchronized procedure of false form and corresponding top pressing platen, the required densities are obtained at different positions of the panel, whether plain or ribbed. The density of cake finally obtained is preferable between 0.25 to 0.4 gm/cc. By varying the shape of the top pressing platen, it is possible to obtain varying thickness in different areas of tile such as thicker at edges and thinner at center. In one of the embodiment of the present invention shown in FIG. 3, the edges and cross bands of the tiles, have thickness of 15 mm whereas the rest of the area of tile has thickness of 9 mm. This makes the tiles light weight with edges of higher strength and overall strong structure by suitable placement of ribs. The tiles can have on facing side, punched holes or fissured deep indentation with varieties of paint coating so as to improve acoustic and aesthetic properties.

### WORKING EXAMPLES

The invention will now be illustrated with working examples, which are intended to be illustrative examples and are not intended to be taken restrictively to imply any limitation on the scope of the present invention.

### Example—1

For preparation of tile weighing 1.9 kg, a slurry is prepared by taking 0.418 kg of mineral fibres and 0.067 kg of organic fibres namely cellulose pulp and synthetic fibre. After fibres are opened, 0.447 kg of flyash is added. To the slurry thus obtained, 0.76 kg of calcium silicate slurry, 0.095 kg of gypsum and 0.114 kg of dry waste are added. The mixture thus formed is then poured into mould where both perform and pressing operations are carried out.

### Example—II

For preparation of a tile weighing 1.6 kg, a slurry is first prepared by mixing 0.233 kg of mineral wool and 0.053 kg of organic fibre namely cellulose pulp and synthetic fibre. After the fibres are opened, 0.225 kg of limestone powder is added. To this slurry, 0.825 kg of hydrated calcium silicate, 0.075 kg of gypsum and 0.090 kg of recirculated waste are added. The mixture is then poured into mould where both perform and pressing operations are carried out.

It is to be noted that the coiling tiles and process of manufacture disclosed herein is susceptible to modifications, changes and adaptations by those skilled in the art. Such variant embodiments incorporating the concepts and features of the present invention, are intended to be within the scope of the present invention, which is further set forth under the following claims:

1-4. (canceled)

5. A process for preparation of ceiling tiles having different densities at desired points comprising the step of preparing a slurry mix of 40-45% hydrated calcium silicate gel and a low density binder; 20-25% reinforcing fibre selected from mineral wool, glass wool and paper pulp; 3-5% gypsum, cellulose pulp and fillers selected from pulverized fly ash and calcium carbonate, pouring the slurry mix into a mould, introducing a false form, subjecting to vacuum and pressure to obtain the more or less material at desired points, removing the false form and further subjecting the semisolid slurry to pressure from top to produce tile with or without reinforcing ribs.

6. The process for preparation of ceiling tiles as claimed in claim 5, wherein the densities of tile finally obtained is preferably between 0.25 to 0.4 gm/cc.

7. The process for preparation of ceiling tiles as claimed in claim 5, wherein the tiles have desired designs on facing side by introducing suitable bottom platen at filter media.

8. Ceiling tiles having different densities at desired locations comprising 40-45% hydrated calcium silicate gel and a low density binder; 20-25% reinforcing fibre selected from mineral wool, glass wool and paper pulp; 3-5% gypsum, cellulose pulp and fillers selected from pulverized fly ash and calcium carbonate.
